(19) United States
(12) Patent Application Publication
(10) Pub. No.: US 2024/0012544 A1
(43) Pub. Date: Jan. 11, 2024

(54) METHOD FOR DETERMINING RESOURCE DISCLOSURE SCOPE AND ELECTRONIC DEVICE

(71) Applicant: BEIJING DAJIA INTERNET INFORMATION TECHNOLOGY CO., LTD., Beijing (CN)

(72) Inventor: Qian SHAO, Beijing (CN)

(21) Appl. No.: 18/349,784

(22) Filed: Jul. 10, 2023

(30) Foreign Application Priority Data
Jul. 11, 2022 (CN) 202210809538.1

(51) Int. Cl. G06F 3/0484; G06F 3/0482; G06T 11/60

(52) U.S. Cl. CPC G06F 3/0484; G06F 3/0482; G06T 11/60; G06T 2200/24; G06F 2203/04803

(57) ABSTRACT

Provided is a method for determining a resource disclosure range. The method includes displaying, in response to a disclosure scope determining operation on a target resource, at least one disclosure scope option on a resource editing page of the target resource, wherein the disclosure scope option is configured to determine a disclosure scope of a first-type resource, the first-type resource being a resource whose disclosure duration is a preset duration; determining, in response to an operation on a target option, a disclosure scope of the target resource as a target scope; and publishing the target resource as the first-type resource, wherein a disclosure scope of the published target resource is the target scope.

### CROSS-REFERENCE TO RELATED APPLICATION

This disclosure is based on and claims priority to Chinese Patent Application No. 202210809538.1, filed on Jul. 11, 2022, the disclosure of which is herein incorporated by reference in its entirety.

### TECHNICAL FIELD

The present disclosure relates to the field of network technologies, and in particular, relates to a method for determining a resource disclosure scope and an electronic device.

### BACKGROUND

With the development of network technology, users can publish multimedia resources (such as video resources, audio resources, image resources, and the like) on multimedia resource platforms online. Taking a video resource as a moment video resource as an example, a user can publish the moment video resource on a multimedia resource platform. After that, other users can view the moment video resource through the multimedia resource platform. The moment video resource is time-sensitive, that is, the moment video resource is a video resource with a short disclosure time (for example, 24 hours).

### SUMMARY

The present disclosure provides a method for determining a resource disclosure scope and an electronic device. The technical solutions of the present disclosure are as follows.

According to an aspect of the present disclosure, a method for determining a resource disclosure scope is provided. The method includes: displaying, in response to a disclosure scope determining operation on the target resource, at least one disclosure scope option on a resource editing page of the target resource, wherein the disclosure scope option is configured to determine a disclosure scope of a first-type resource, the first-type resource being a resource whose disclosure duration is a preset duration; determining, in response to an operation on a target option, a disclosure scope of the target resource as a target scope, wherein the target scope indicates to disclose the target resource to a target-type account, and the target option is any one of the at least one disclosure scope option; and publishing the target resource as the first-type resource, wherein a disclosure scope of the published target resource is the target scope.

According to another aspect of the present disclosure, an electronic device is provided. The electronic device includes: one or more processors and a memory for storing one or more instructions executable by the processors, wherein the one or more instructions, when loaded and executed by the processors, cause the processors to perform: displaying, in response to a disclosure scope determining operation on the target resource, at least one disclosure scope option on a resource editing page of the target resource, wherein the disclosure scope option is configured to determine a disclosure scope of a first-type resource, the first-type resource being a resource whose disclosure duration is a preset duration; determining, in response to an operation on a target option, a disclosure scope of the target resource as a target scope, wherein the target scope indicates to disclose the target resource to a target-type account, and the target option is any one of the at least one disclosure scope option; and publishing the target resource as the first-type resource, wherein a disclosure scope of the published target resource is the target scope.

According to another aspect of the present disclosure, a non-volatile computer-readable storage medium is provided. The non-volatile computer-readable storage medium stores at least one instruction therein, wherein the at least one instruction, when executed by a processor of an electronic device, cause the electronic device to perform: displaying, in response to a disclosure scope determining operation on a target resource, at least one disclosure scope option on a resource editing page of the target resource, wherein the disclosure scope option is configured to determine a disclosure scope of a first-type resource, the first-type resource being a resource whose disclosure duration is a preset duration; determining, in response to operation on a target option, a disclosure scope of the target resource as a target scope, wherein the target scope indicates to disclose the target resource to a target-type account, and the target option is any one of the at least one disclosure scope option; and publishing the target resource as the first-type resource, wherein a disclosure scope of the published target resource is the target scope.

### BRIEF DESCRIPTION OF DRAWINGS

FIG. 1 shows a schematic structural diagram of an electronic device according to an exemplary embodiment;

FIG. 2 shows a flowchart of a method for determining a resource disclosure scope according to an exemplary embodiment;

FIG. 3 shows an example diagram of a page display according to an exemplary embodiment;

FIG. 4 shows an example diagram of another page display according to an exemplary embodiment;

FIG. 5 shows an example diagram of another page display according to an exemplary embodiment;

FIG. 6 shows a flowchart of another method for determining a resource disclosure scope according to an exemplary embodiment;

FIG. 7 shows an example diagram of another page display according to an exemplary embodiment;

FIG. 8 shows a flowchart of another method for determining a resource disclosure scope according to an exemplary embodiment;

FIG. 9 shows an example diagram of another page display according to an exemplary embodiment;

FIG. 10 shows an example diagram of another page display according to an exemplary embodiment;

FIG. 11 shows an example diagram of another page display according to an exemplary embodiment;

FIG. 12 shows an example diagram of another page display according to an exemplary embodiment;

FIG. 13 shows an example diagram of another page display according to an exemplary embodiment;

FIG. 14 shows a schematic structural diagram of an apparatus for determining a resource disclosure scope according to an exemplary embodiment; and

FIG. 15 is a schematic structural diagram of another apparatus for determining a resource disclosure scope according to an exemplary embodiment.

### DETAILED DESCRIPTION

User information (including but not limited to user equipment information, user personal information, and the like) and data (including but not limited to multimedia resources, disclosure scope, and the like) involved in the present disclosure are all information and data authorized by users or fully authorized by all parties.

First, application scenarios of embodiments of the present disclosure are introduced.

A method for determining a resource disclosure scope according to embodiments of the present disclosure is applied to a scenario of setting a disclosure scope of a moment-type resource. In the related art, in a case where a user publishes a multimedia resource that is not time-sensitive, a visible scope (that is, disclosure scope) of the multimedia resource is located on a resource publishing page. Then, after the user publishes the multimedia resource, the multimedia resource is disclosed to other user accounts according to the disclosure scope. However, in a current technical solution, the disclosure scope of the moment-type resource cannot be set, and by default, the disclosure scope of the moment-type resource is that all user accounts in the multimedia resource platform can view the multimedia resource. That is, after the user publishes the moment-type resource, any user in the multimedia resource platform can view the moment-type resource, resulting in poor privacy of the moment-type resource, and affecting the user's experience of publishing the moment-type resource.

It should be noted that multimedia resources are not limited in the embodiments of the present disclosure. For example, a multimedia resource is a video resource (such as a short video resource, a long video resource, and the like). For another example, a multimedia resource is an audio resource. For another example, a multimedia resource is an image resource.

To solve the above problem, the embodiments of the present disclosure provide the method for determining the resource disclosure scope. In this method, an electronic device displays a resource editing page that includes disclosure scope options for determining a disclosure scope of a moment-type resource (such as “Visible to all”, “Visible to some”, “Visible to friend”, and the like). Then, the electronic device adjusts the disclosure scope of the moment-type resource in response to adjustment operation implemented by the user.

Exemplarily, the electronic device adjusts the disclosure scope of the moment-type resource to “Visible to some”. Alternatively, the electronic device adjusts the disclosure scope of the moment-type resource to “Visible to all”. Alternatively, the electronic device adjusts the disclosure scope of the moment-type resource to “Visible to friend”. In this way, in the case that the electronic device publishes the moment-type resource, the disclosure scope of the moment-type resource can be adjusted. Therefore, the privacy of the moment-type resource is enhanced, and the users' experience of publishing the moment-type resource is improved and the users are more willing to post the moment-type resources in a multimedia platform.

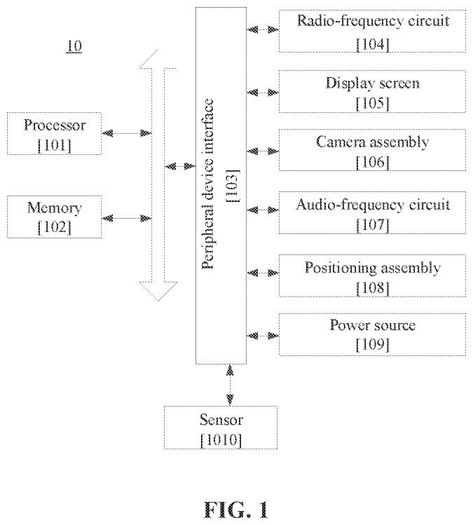

FIG. 1 shows a schematic structural diagram of an electronic device 10 according to an exemplary embodiment. The electronic device 10 includes a processor 101 and a memory 102.

The processor 101 includes one or more processing cores, such as a 4-core processor, an 8-core processor, and the like. The processor 101 includes an application processor (AP), a modem processor, a graphics processing unit (GPU), an image signal processor (ISP), a controller, a memory, a video codec, a digital signal processor (DSP), a baseband processor, and/or a neural-network processing unit (NPU), and the like. In some embodiments, different processing units are independent devices or are integrated in one or more processors.

The memory 102 includes one or more computer-readable storage media, which are non-transitory. In some embodiments, the memory 102 further includes a high-speed random-access memory and a non-volatile memory, such as one or more magnetic disk memory devices, and flash memory devices. In some embodiments, the non-transitory computer-readable storage medium in the memory 102 is configured to store at least one instruction, wherein the at least one instruction, when loaded and executed by the processor 101, causes the processor 101 to perform the method for determining the resource disclosure scope provided by the embodiments of the present disclosure.

In some embodiments, the electronic device 10 further includes a peripheral device interface 103 and at least one peripheral device. The processor 101, the memory 102, and the peripheral device interface 103 are connected to each other by buses or signal lines. Each peripheral device is connected to the peripheral device interface 103 via a bus, a signal line, or a circuit board. In some embodiments, the peripheral device includes at least one of a radio-frequency circuit 104, a display screen 105, a camera assembly 106, an audio-frequency circuit 107, a positioning assembly 108, and a power source 109.

The peripheral device interface 103 is configured to connect the at least one peripheral device associated with an input/output (I/O) to the processor 101 and the memory 102. In some embodiments, the processor 101, the memory 102, and the peripheral device interface 103 are integrated on the same chip or circuit board, and in some other embodiments, any one or two of the processor 101, the memory 102, and the peripheral device interface 103 are implemented in a separate chip or circuit board, which are not limited in the embodiment.

The radio-frequency circuit 104 is configured to receive and transmit a radio frequency (RF) signal, which is also referred to as an electromagnetic signal. The radio-frequency circuit 104 is communicated with a communication network and other communication devices via the electromagnetic signal. The radio-frequency circuit 104 converts an electrical signal into an electromagnetic signal for transmission or converts the received electromagnetic signal into an electrical signal. In some embodiments, the radio-frequency circuit 104 includes an antenna system, an RF transceiver, one or more amplifiers, a tuner, an oscillator, a digital signal processor, a codec chipset, a user identity module card, or the like. In some embodiments, the radio-frequency circuit 104 is communicated with other electronic devices through at least one wireless communication protocol. The wireless communication protocol includes but is not limited to, a metropolitan area network, various generations of mobile communication networks (e.g., 2G, 3G, 4G, and 5G), a wireless local area network, and/or wireless fidelity (Wi-Fi) network. In some embodiments, the radio-frequency circuit 104 further includes a circuit related to near-field communication (NFC), which is not limited in the present disclosure.

The display screen 105 is configured to display a user interface (UI). The UI includes graphics, text, icons, videos, and any combination thereof. In the case that the display screen 105 is a touch display screen, the display screen 105 is further capable of acquiring a touch signal on or above a surface of the display screen 105. The touch signals are input into the processor 101 as a control signal for processing. The display screen 105 is also configured to provide virtual buttons and/or a virtual keyboard, which is/are also referred to as soft buttons and/or a soft keyboard. In some embodiments, one display screen 105 may be disposed on a front panel of the electronic device 10. In some embodiments, the display screen 105 is made from materials such as a liquid crystal display (LCD) and an organic light-emitting diode (OLED).

The camera assembly 106 is configured to acquire images or videos. Optionally, the camera assembly 106 includes a front camera and a rear camera. Usually, the front camera is disposed on a front panel of the electronic device, and the rear camera is disposed on the back of the electronic device. In some embodiments, the audio-frequency circuit 107 includes a microphone and a speaker. The microphone is configured to acquire sound waves from users and environments, and convert the sound waves into electrical signals, which are then input to the processor 101 to be processed, or input to the radio-frequency circuit 104 for voice communication. For stereo acquisition or noise reduction, in some embodiments, there are a plurality of microphones disposed at different parts of the electronic device 10. In some embodiments, the microphone is an array microphone or an omnidirectional acquisition microphone. The speaker is configured to convert electrical signals from the processor 101 or the radio-frequency circuit 104 into sound waves. In some embodiments, the speaker is a traditional thin-film speaker or a piezoelectric ceramic speaker. In the case that the speaker is a piezoelectric ceramic speaker, the electric signals may be converted into sound waves not only human-audible sound waves, but also the sound waves which are inaudible to human beings for distance measurement and the like. In some embodiments, the audio-frequency circuit 107 further includes a headphone jack.

The positioning component 108 is configured to determine a current geographic location of the electronic device 10 to implement navigation or a location-based service (LBS).

The power source 109 is configured to supply power for various components in the electronic device 10. The power supply 109 is an alternating current, a direct-current, a disposable battery, or a rechargeable battery. In the case where the power supply 109 includes the rechargeable battery, the rechargeable battery may support wired charging or wireless charging. The rechargeable battery is also configured to support the fast charging technology.

In some embodiments, the electronic device 10 further includes one or more sensors 1010. The one or more sensors 1010 include, but are not limited to, an acceleration sensor, a gyro sensor, a pressure sensor, a fingerprint sensor, an optical sensor, and a proximity sensor.

The acceleration sensor can detect magnitudes of acceleration on three coordinate axes of a coordinate system established based on the electronic device 10. The gyro sensor can detect a body direction and a rotation angle of the electronic device 10, and cooperate with the acceleration sensor to acquire a 3D motion of the user on the electronic device 10. The pressure sensor is disposed on a side frame of the electronic device 10 and/or on a lower layer of the display screen 105. In some embodiments, the pressure sensor is disposed on the side frame of the electronic device 10 and can detect a grip signal of the user on the electronic device 10. The fingerprint sensor is configured to acquire a user's fingerprint. The optical sensor is configured to acquire ambient light intensity. The proximity sensor, also referred to as a distance sensor, is usually disposed on the front panel of the electronic device 10. The proximity sensor is configured to acquire a distance between a user and a front surface of the electronic device 10.

The executive body of the method for determining the resource disclosure scope provided by the present disclosure is an apparatus for determining a resource disclosure scope, and the executive apparatus is configured on the electronic device shown in FIG. 1. Moreover, the executive apparatus can also be configured on a central processing unit (CPU) of the electronic device, or on a control module for data processing in the electronic device. In the embodiment of the present disclosure, the method for determining the resource disclosure scope provided by the embodiment of the present disclosure is described by taking execution of the method with the electronic device as an example.

In some embodiments, the electronic device is configured to provide voice and/or data connectivity services for the user. Exemplarily, the electronic device has different names, such as UE terminal, terminal unit, terminal station, mobile station, remote station, remote terminal, mobile device, wireless communication device, vehicle user device, terminal agent, terminal apparatus, or the like.

In some embodiments, the electronic device is a handheld device, a vehicle device, a wearable device, or a computer having a communication function, which is not limited by the embodiment of the present disclosure. For example, the handheld device is a smartphone. The in-vehicle device is a vehicle navigation system. The wearable device is a smart bracelet. The computer is a personal digital assistant (PDA) computer, a tablet computer, and a laptop computer.

After the application scenario and implementation environment of the embodiment of the present disclosure have been described, the method for determining the resource disclosure scope provided by the embodiments of the present disclosure is described in detail below with reference to the implementation environment shown in FIG. 1.

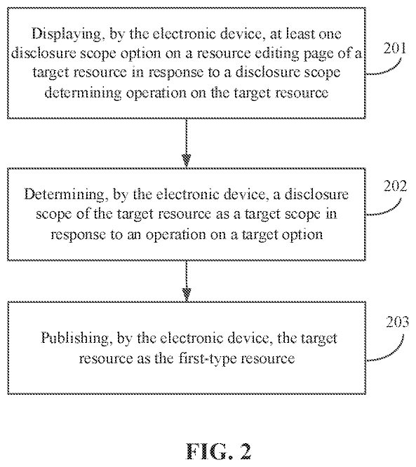

FIG. 2 shows a flowchart of a method for determining a resource disclosure scope according to an exemplary embodiment. As shown in FIG. 2, the method is executed by an electronic device, including steps 201 to 203.

In 201, the electronic device displays at least one disclosure scope option on a resource editing page of a target resource in response to a disclosure scope determining operation on the target resource.

The target resource is a resource to be published, and the disclosure scope option is configured to determine a disclosure scope of a first-type resource. It should be noted that in the embodiment of the present disclosure, a disclosure scope of a multimedia resource indicates a scope to disclose the multimedia resource to accounts in a multimedia resource platform, that is, the scope that the multimedia resource can be viewed via the multimedia resource platform.

In the embodiment of the present disclosure, the first-type resource is a resource whose disclosure duration is a preset duration. That is, the first-type resource can be browsed via the multimedia resource platform within the preset duration after the first-type resource is published. Beyond the preset duration after the first-type resource is published, the first-type resource can only be browsed by an account that publishes the first-type resource. It should be noted that the embodiment of the present disclosure does not limit the preset duration. For example, the preset duration is 12 hours. For another example, the preset duration is 24 hours. For another example, the preset duration is 1 hour.

In some embodiments, the resource editing page is configured to edit the target resource, and exemplarily, the resource editing page includes the target resource. It should be noted that the embodiment of the present disclosure does not limit the editing function of the resource editing page. For example, the resource editing page is configured to set filters for video resources. For another example, the resource editing page is also configured to set background music for video resources. For another example, the resource edit page is also configured to set subtitles for video resources.

In some embodiments, displaying, by the electronic device, at least one disclosure scope option on the resource editing page of the target resource in response to the disclosure scope determining operation on the target resource includes at least one of the following cases.

In the first case, the at least one disclosure scope option is displayed on the resource editing page in response to an editing completion operation on the target resource. For example, the editing completion operation is an operation on a first publishing option on the resource editing page.

In the second case, the at least one disclosure scope option is displayed on the resource editing page in response to an operation on a disclosure scope control on the resource editing page. The disclosure scope control is configured to provide a disclosure scope determining function for the first-type resource.

That is, in the embodiment of the present disclosure, the disclosure scope determining operation on the target resource can be implemented by at least one of the above operations, which is not limited by the present disclosure.

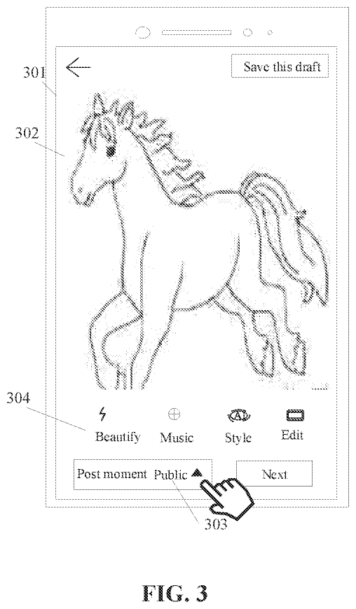

Exemplarily, as shown in FIG. 3, the resource editing page 301 may include a target resource 302 and a disclosure scope control 303, and the electronic device can display at least one disclosure scope option (a “Public” option for example) in response to an operation on the disclosure scope control 303. In some embodiments, the resource editing page 301 further includes at least one editing option 304 (e.g., a beautifying option, a background music option, a style option, an editing option, and the like).

In some embodiments, the electronic device displays a first window on the resource editing page in response to the disclosure scope determining operation on the target resource.

In some embodiments, the at least one disclosure scope option includes at least one of a first option, a second option, a third option, a fourth option, and a fifth option.

The first option indicates disclosure to all accounts in the multimedia resource platform. That is, any user (account) can browse the multimedia resource via the multimedia resource platform. Moreover, a user who has not registered an account on the multimedia resource platform can also browse the multimedia resource.

The second option indicates disclosure to a target account, which is an account publishing the target resource. That is, only the target account can browse the multimedia resource, and other accounts (accounts other than the target account) on the multimedia resource platform cannot browse the multimedia resource.

The third option indicates disclosing the multimedia resource to a first type of accounts, which are accounts associated with the target account. Exemplarily, taking the target account as an account A as an example, the first type of accounts includes at least one of accounts following the account A, accounts followed by the account A, and accounts following and followed by the account A.

The fourth option indicates disclosing the multimedia resource to a second type of accounts, which are accounts the target account selects. That is, the accounts specified by the target account can browse the multimedia resource.

The fifth option indicates disclosing the multimedia resource to all accounts other than the second type of accounts. That is, all the accounts other than those specified by the target account can browse the multimedia resource.

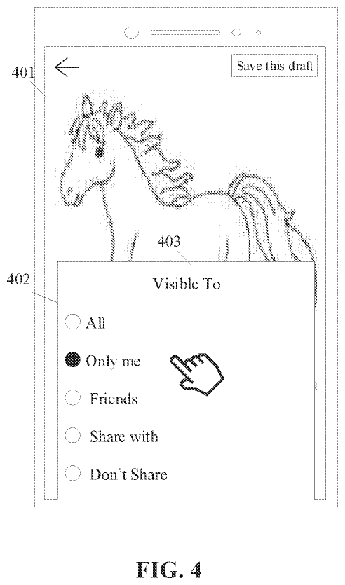

Exemplarily, taking the disclosure scope determining operation as an operation on the exposure scope control as an example, as shown in FIG. 4 with reference to FIG. 3, the electronic device displays a first window 402 on a resource editing page 401 in response to an operation (such as click operation, sliding operation, long press operation, or the like) on a disclosure scope control 303. The first window 402 includes a first option (such as a “All” option, namely a “Public” option), a second option (such as an “Only Me” option, namely a “Private” option), a third option (such as a “Friends” option, namely a “Friend” option), a fourth option (such as a “Share with” option, namely a “Part” option), and a fifth option (such as a “Don't share” option, namely the “Part” option). In some embodiments, the first window 402 further includes a first prompt message 403, wherein the first prompt message 403 indicates adjustment on the disclosure scope of the target resource, for example, the first prompt message 403 is “Visible To”.

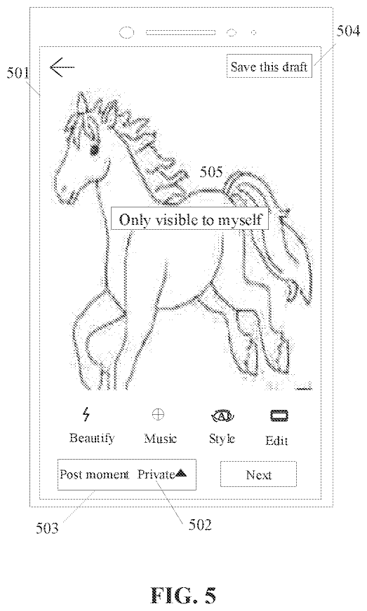

Exemplarily, taking the disclosure scope determining operation as an editing completion operation on the target resource (for example, an operation on the first publishing option) as an example as shown in FIG. 5, a resource editing page 501 further includes a first publishing option (for example, a “Post moment” option) 503. With reference to FIG. 5 and FIG. 4, the electronic device displays the first window 402 shown in FIG. 4 in response to the operation on the “Post moment” option 503.

In 202, the electronic device determines a disclosure scope of the target resource as a target scope in response to an operation on a target option.

The target scope indicates disclosing the first-type resource to the target-type account, and the target option is any one of the at least one disclosure scope option; and the target scope is a disclosure scope corresponding to the target option.

In the embodiment of the present disclosure, in the case that the target option is the first option, the target-type accounts are all the accounts in the multimedia resource platform. In the case that the target option is the second option, the target-type account is the target account. In the case that the target option is the third option, the target-type accounts are the first type of accounts. In the case that the target option is the fourth option, the target-type accounts are the second type of accounts. In the case that the target option is the fifth option, the target-type accounts are all the accounts other than the second type of accounts.

In some embodiments, in the case that the target option is the fifth option, the target-type accounts are the first type of accounts other than the second type of accounts in the first type of accounts.

It can be understood that visible accounts (namely the target-type accounts) that can browse the target resource can be changed by the different scope options. In some embodiments, the method of the present disclosure provides a resource editing page of a target resource and the resource editing page includes various options on the types of accounts who can browse a published resource (e.g., the target resource). In some examples, the resources are the moment video resources with a short disclosure time (for examples, 12 or 24 hours). Even if it is a moment-type resource, the options for visible scope are provided to a user, and a user's selection on the disclosure option can be achieved in an easy and convenient way. Therefore, the user is enabled to adjust the visible scope of a moment-type resource in accordance with his/her own situation, and shares the moment-type resource to whoever the user desires in a multimedia resource platform, such that the privacy of the moment-type resource is enhanced and the user's experience of publishing the moment-type resource is improved.

In some embodiments, the electronic device hides the first window in response to the operation on the target option (e.g., the first option, the second option, or the third option).

In some embodiments, the disclosure scope option that is displayed by the electronic device on the resource editing page is the target option in response to the operation on the target option.

Exemplarily, as shown in FIG. 5 with reference to FIG. 4, the electronic device hides the first window 402 in response to an operation on the “Only Me” option, and the disclosure scope option displayed on the resource editing page 501 is the “Private” option 502.

In some embodiments, after the disclosure scope of the first-type resource is determined by the electronic device as the target scope in response to the operation on the target option, the electronic device displays a first prompt message on the resource editing page, and the first prompt message is configured to prompt that the disclosure scope of the target resource is the target scope.

Exemplarily, with reference to FIG. 4 and FIG. 5, the electronic device displays a first prompt message 505 after receiving the operation on the “Only Me” option, for example, the first prompt message 505 is “Only visible to myself”.

In this way, the user can be prompted of the disclosure scope of the target resource, such that wrong selection of the user is avoided, and the user's experience of publishing the target resource is improved.

In 203, the electronic device publishes the target resource as the first-type resource.

The disclosure scope of the target resource is the target scope after the target resource is published as the first-type resource.

In some embodiments, the electronic device publishes the target resource as the first-type resource in response to the operation on the target option. In the example illustrated in FIG. 5, after the target option (“Private”) 502 is activated, the target resource is published to the target account only.

The technical solution provided by the above embodiment provides the method for determining the resource disclosure scope, which can enable the user to adjust the visible scope of the moment-type resource in accordance with his/her own situation, such that the privacy of the moment-type resource is enhanced and the user's experience of publishing the moment-type resource is improved.

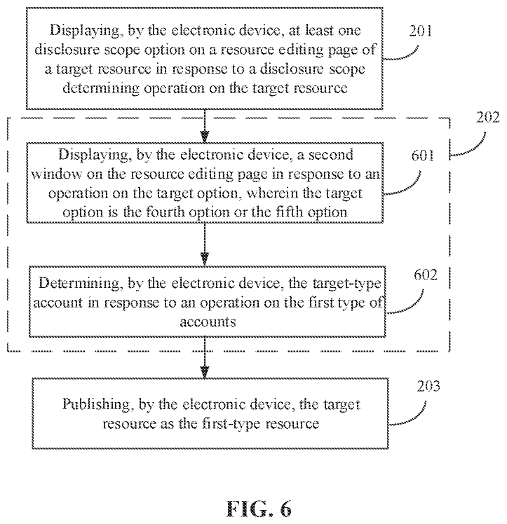

In other embodiments, as shown in FIG. 6, step 202 includes steps 601 to 602.

In 601, the electronic device displays a second window on the resource editing page in response to the operation on the target option, wherein the target option is the fourth option or the fifth option.

The second window includes the first type of accounts. That is, the electronic device displays the second window on the resource editing page in response to the operation on the fourth option; or, the electronic device displays the second window on the resource editing page in response to the operation on the fifth option.

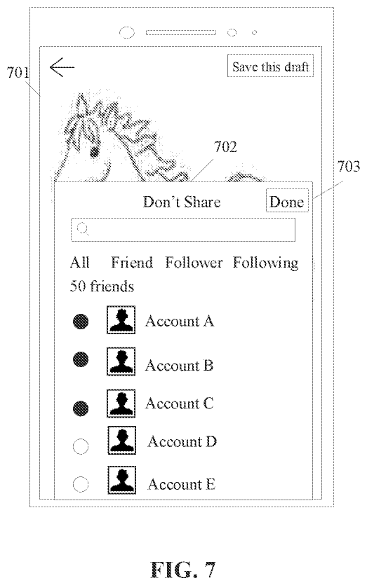

Exemplarily, as shown in FIG. 7 with reference to FIG. 4, the second window 702 is displayed on the resource editing page 701 in response to the operation on the “Don't Share” option, and includes an “All” list, a “Friend” list, and a “Follower” list. The second window 702 further includes a “Done” option 703 which is configured to trigger determined target-type accounts.

In 602, the electronic device determines the target-type accounts in response to an operation on the first type of accounts.

In some embodiments, in the case that the target option is the fourth option, the electronic device determines that the target-type accounts are the second type of accounts. In the case that the target option is the fifth option, the electronic device determines that the target-type accounts are all the accounts other than the second type of accounts.

Exemplarily, with reference to FIG. 7, determined accounts in the first type of accounts include an account A, an account B, and an account C. The electronic device determines that the target-type accounts include the account A, the account B, and the account C in response to the operation on the fourth option. The electronic device determines that the target-type accounts include all accounts in the “All” list other than the account A, the account B, and the account C in response to the operation on the fifth option.

In some embodiments, the electronic device hides the second window in response to the operation on the first type of accounts.

The technical solution provided by the above embodiment enriches the manner of setting the disclosure scope of the first-type resource, and improves the user's experience of publishing the first-type resource.

In some embodiments, the resource editing page further includes the first publishing option and the target resource, wherein the first publishing option is configured to publish the target resource as the first-type resource. The electronic device publishes the target resource as the first-type resource in response to the operation on the first publishing option, and the disclosure scope of the target resource is the target scope after the target resource is published as the first-type resource.

In some embodiments, the disclosure scope option is located in the first publishing option.

Exemplarily, the resource editing page 501 further includes the first publishing option (for example, the “Post moment” option) 503 with reference to FIG. 5. In the illustrated example, the first publishing option (e.g., “post moment” 503) is located at the same region as the disclosure scope option (e.g., 502). The target resource is published as a moment-type resource (namely the first-type resource) in response to an operation on the “Post moment” option 503, and the disclosure scope of the target resource published as a moment-type resource is “Only Me”.

According to the technical solution provided by the above embodiment, the disclosure scope of the published first-type resource can be disclosed according to a selected scope of the user, thereby improving the user's experience of publishing the first-type resource.

It should be noted that the user may have to select the disclosure scope again in the case that he/she republishes the target resource after saving the target resource, which prolongs the process of resource publishing of the user.

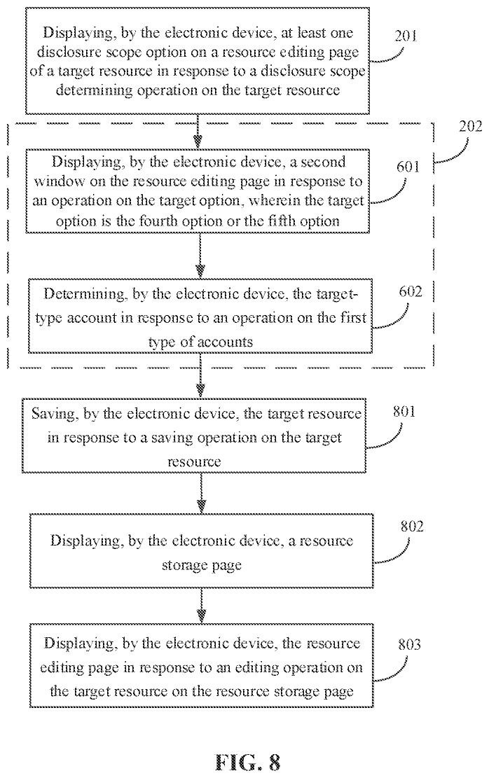

In other embodiments, as shown in FIG. 8, the method for determining the resource disclosure scope further includes steps 801 to 803.

In 801, the electronic device saves the target resource in response to a saving operation on the target resource.

The disclosure scope of the saved target resource is the target scope. The saving operation is configured to save the target resource locally.

Exemplarily, the resource editing page 501 further includes a “Save this draft” option 504 with reference to FIG. 5. The electronic device saves the target resource locally (e.g., in a storage space of the electronic device) in response to the user's operation on the “Save this draft” option 504 (i.e. save operation).

In 802, the electronic device displays a resource storage page.

The resource storage page includes the target resource.

In some embodiments, the electronic device displays the resource storage page in response to a first operation of the user. The first operation is configured to display the resource storage page (for example, the Draft Box)

In 803, the electronic device displays the resource editing page in response to an editing operation on the target resource on the resource storage page.

The resource editing page includes the target resource, and the disclosure scope option displayed on the resource editing page is the target option.

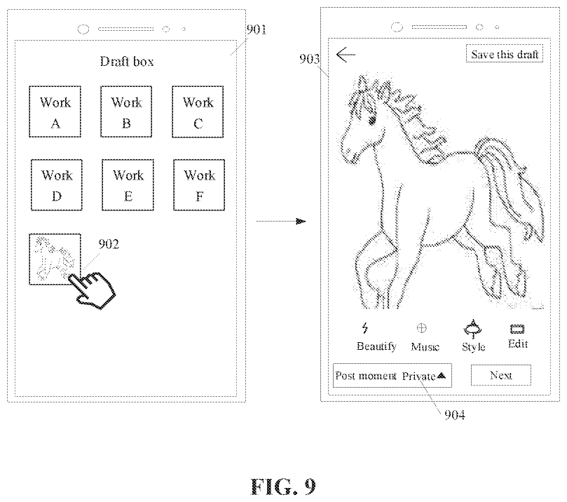

Exemplarily, as shown in FIG. 9, the electronic device displays the resource editing page 903 in response to the operation on the target resource 902 on the resource storage page 901. In the case that the electronic device saves the target resource, the disclosure scope of the target resource is “Private”, and the disclosure scope option displayed on the resource editing page 903 is the “Private” option 904.

According to the technical solutions provided by the above embodiments, in the case that the electronic device saves the target resource, the disclosure scope of the target resource can be saved simultaneously. In this way, in the case that the user republishes the target resource, he/she can publish the target resource according to the previously saved disclosure scope without having to select the disclosure scope for the second time, such that the user's experience of publishing the first-type resource is improved.

It should be noted that the user needs to republish the target resource in case of an abnormality on the resource editing page. Thus, the user needs to reselect a disclosure scope option, which prolongs the process of resource publishing of the user.

In some embodiments, the target resource is saved in case of the abnormality on the resource editing page, and the disclosure scope of the saved target resource is the target scope. In response to a page recovery operation, the resource editing page is redisplayed, and the redisplayed resource editing page includes the target resource, and the disclosure scope option displayed on the redisplayed resource editing page is the target option.

It should be noted that the abnormality on the resource editing page in the embodiments of the present disclosure means that the resource editing page is abnormally closed (for example, an application program crashes).

In some embodiments, after the abnormality occurs on the resource editing page, the electronic device displays an abnormality prompt message that indicates to redisplay the resource editing page. The electronic device redisplays the resource editing page in response to an operation on the abnormality prompt message (i.e., the page recovery operation).

According to the technical solutions provided by the above embodiments, in the case that the user republishes the target resource, he/she can publish the target resource according to the previously saved disclosure scope without having to select the disclosure scope for the second time, such that the user's experience of publishing the first-type resource is improved.

In some embodiments, after determining the disclosure scope of the first-type resource as the target scope in response to the operation on the target option, the electronic device hides the disclosure scope option on the resource editing page.

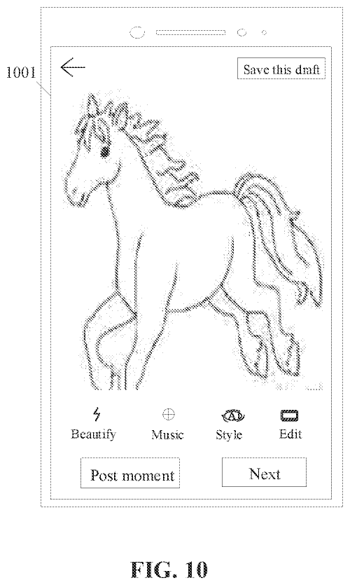

Exemplarily, as shown in FIG. 10 with reference to FIG. 4, after the operation on the “Only Me” option is received, the “Only Me” option does not exist on the resource editing page 1001 displayed by the electronic device.

In this way, the electronic device hides the disclosure scope option on the resource editing page, thereby preventing the user from reselecting the disclosure scope by a false touch.

In some embodiments, the disclosure scope control is located in the region other than the first publishing option on the resource editing page.

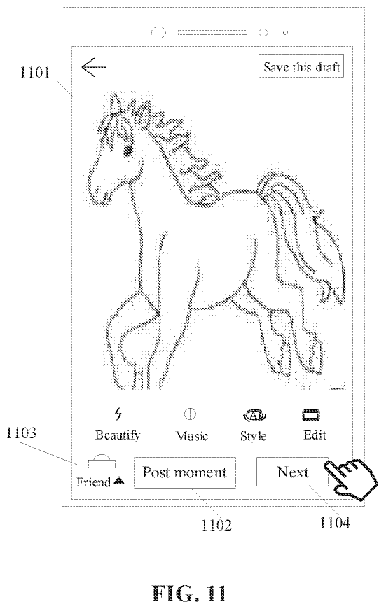

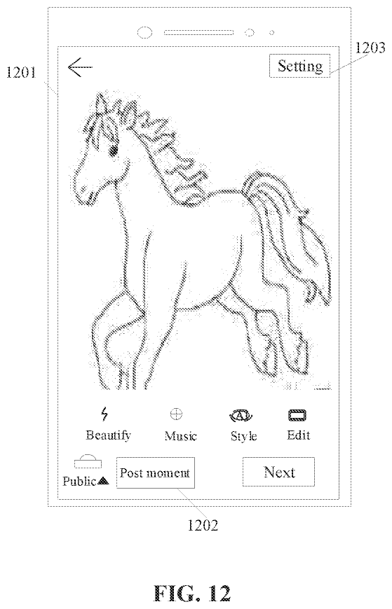

FIG. 11 shows an exemplary embodiment where the disclosure scope control is located in the same region as the first publishing option on the resource editing page. As shown in FIG. 11, the resource editing page 1101 includes a first publishing option 1102 and a disclosure scope control 1103, wherein the disclosure scope control 1103 is located on one side of the first publishing option 1102 at the same region. Alternatively, as shown in FIG. 12, the resource editing page 1201 includes a first publishing option 1202 and a disclosure scope control (e.g., a “Settings” option) 1203. The disclosure scope control 1203 is located at the top of the resource editing page 1201. Exemplarily, the electronic device displays at least one disclosure scope option for the user to select in response to an operation on the disclosure scope control 1203.

In the embodiments of the present disclosure, the disclosure scope option on the resource editing page is also configured to determine the disclosure scope of a second-type resource, and the disclosure duration of the second-type resource is greater than the preset duration.

It should be noted that the embodiments of the present disclosure do not limit the disclosure duration of the second-type resource. Generally, the disclosure duration of the second-type resource is infinite. That is, the disclosure scope of the second-type resource always remains the scope corresponding to the first option in the case where the user does not adjust the disclosure scope.

In some embodiments, the resource editing page further includes a resource publishing page entry. The electronic device displays the resource publishing page in response to an operation on the resource publishing page entry. The resource publishing page includes a disclosure scope option and a second publishing option, wherein the disclosure scope option is also configured to trigger and adjust the disclosure scope of the second-type resource; the second publishing option is configured to trigger to publish the target resource as a second-type resource. The disclosure scope option of the resource publishing page is the target option.

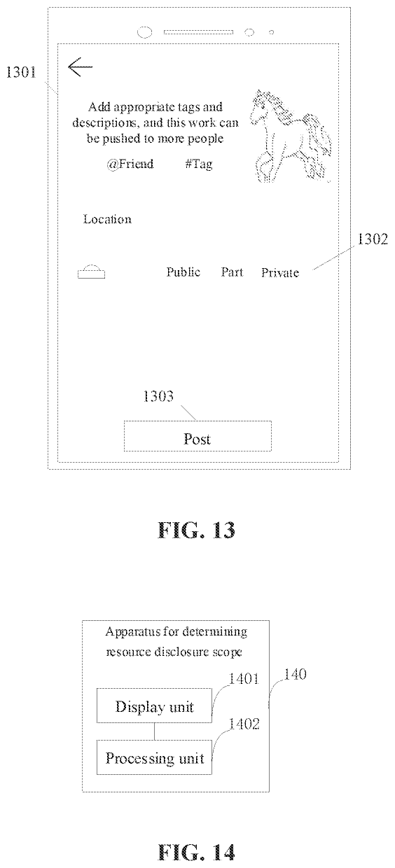

Exemplarily, with reference to FIG. 11, the electronic device displays at least one disclosure scope option for the user to select in response to an operation on the disclosure scope control 1103 on the resource editing page 1101, and displays the “Friend” option based on the target option selected by the user. The resource editing page 1101 further includes the resource publishing page entry (e.g., the “Next” option) 1104. The electronic device displays a resource publishing page 1301 as shown in FIG. 13 in response to an operation on the resource publishing page entry 1104. The resource publishing page 1301 includes a disclosure scope option 1302 and a second publishing option 1303, wherein the disclosure scope option or target option is shown as the “Friend” option (@Friend).

According to the technical solutions provided by the above embodiments, the determined target option on the resource editing page can be synchronized to the resource publishing page and displayed on the resource publishing page. By providing the resource editing page that enables selection of disclosure scope, the user can set the disclosure scope option while editing the target resource, thereby avoiding omitting to set the disclosure scope on the resource publishing page, and improving the experience of publishing the multimedia resource.

In some embodiments, the method described above is implemented by an apparatus for determining a resource disclosure scope. To implement the above functions, the apparatus for determining the resource disclosure scope includes corresponding hardware structures and/or software modules for performing the respective functions. It should be readily appreciated by those skilled in the art that the embodiments of the present disclosure can be implemented by hardware or by a combination of hardware and computer software based on the modules and algorithm steps of the examples described in the embodiments disclosed herein. Whether a function is performed by hardware or computer software-driven hardware depends on the particular applications and design constraints of the technical solutions. Those skilled in the art can implement the described functions for each particular application by different methods, but such implementation should not be considered to exceed the scope of the embodiments of the present disclosure.

In the embodiments of the present disclosure, function modules of the apparatus for determining the resource disclosure scope and the like may be divided according to the above-described examples of the method, for example, the function modules may be divided according to the functions, or two or more functions may be integrated in one processing module. The above-mentioned integrated module may be implemented in the form of a hardware or in the form of a software function module. It should be noted that the division of the modules in the embodiments of the present disclosure is schematic and is only a logical function division, and there may be other division modes in actual implementation.

FIG. 14 shows a structural block diagram of an apparatus for determining a resource disclosure scope according to an exemplary embodiment. Referring to FIG. 14, the apparatus for determining the resource disclosure scope includes a display unit 1401 and a processing unit 1402.

The display unit 1401 is configured to display, in response to a disclosure scope determining operation on a target resource, at least one disclosure scope option on a resource editing page of the target resource, wherein the disclosure scope option is configured to determine a disclosure scope of a first-type resource, the first-type resource being a resource whose disclosure duration is a preset duration. The processing unit 1402 is configured to determine, in response to an operation on a target option, a disclosure scope of the target resource as a target scope, wherein the target scope indicates to disclose the target resource to a target-type account, and the target option is any one of the at least one disclosure scope option. The processing unit 1402 is configured to publish the target resource as a first-type resource, wherein a disclosure scope of the published target resource is the target scope.

In some embodiments, the display unit 1401 is configured to perform at least one of: displaying, in response to an editing completion operation on the target resource, at least one disclosure scope option on a resource editing page; and displaying, in response to an operation on a disclosure scope control on the resource editing page, at least one disclosure scope option on the resource editing page.

In some embodiments, the display unit 1401 is configured to display, in response to the disclosure scope determining operation, a first window on the resource editing page, and displaying the at least one disclosure scope option on the first window.

In some embodiments, the at least one disclosure scope option includes at least one of a first option, a second option, a third option, a fourth option, and a fifth option; wherein in a case the target option is the first option, the target-type accounts are all accounts in a multimedia resource platform; in a case that the target option is the second option, the target-type account is a target account, the target account being an account publishing the target resource; in a case that the target option is the third option, the target-type accounts are a first type of accounts, the first type of accounts being accounts associated with the target account; in a case that the target option is the fourth option, the target-type accounts are a second type of accounts, the second type of accounts being accounts selected by the target account; in a case that the target option is the fifth option, the target-type accounts are all the accounts other than the second type of accounts.

In some embodiments, the display unit 1401 is further configured to perform at least one of: displaying, in response to an operation on the fourth option, a second window on the resource editing page, wherein the second window includes the first type of accounts, and determining the target-type accounts in response to an operation on the first type of accounts; and displaying, in response to an operation on the fifth option, a second window on the resource editing page, wherein the second window includes the first type of accounts, and determining the target-type accounts in response to an operation on the first type of accounts.

In some embodiments, the resource editing page further includes a first publishing option and the target resource, wherein the first publishing option is configured to publish the target resource as a first-type resource. The processing unit 1402 is further configured to publish, in response to an operation on the first publishing option, the target resource as a first-type resource.

In some embodiments, the processing unit 1402 is further configured to save the target resource in response to a saving operation on the target resource; wherein the disclosure scope of the saved target resource is the target scope. The display unit 1401 is further configured to display a resource storage page, wherein the resource storage page includes the target resource. The display unit 1401 is further configured to display the resource editing page in response to an editing operation on the target resource on the resource storage page, wherein the resource editing page includes the target resource, and the disclosure scope option displayed on the resource editing page is the target option.

In some embodiments, the processing unit 1402 is further configured to save the target resource in case of an abnormality on the resource editing page, wherein the disclosure scope of the saved target resource is the target scope. The display unit 1401 is further configured to redisplay the resource editing page in response to a page recovery operation, the redisplayed resource editing page includes the target resource, and the disclosure scope option displayed on the redisplayed resource editing page is the target option.

In some embodiments, the display unit 1401 is further configured to hide the disclosure scope option on the resource editing page.

In some embodiments, the resource editing page further includes a resource publishing page entry. The display unit 1401 is further configured to display a resource publishing page in response to an operation on the resource publishing page entry, wherein the resource publishing page includes the disclosure scope option and a second publishing option, wherein the disclosure scope option is also configured to determine a disclosure scope of the second-type resource, the second-type resource being a resource whose disclosure duration is greater than the preset duration; and the second publishing option is configured to publish the target resource as the second-type resource, the disclosure scope option of the resource publishing page being the target option.

With respect to the apparatus for determining the resource disclosure scope in the above-described embodiments, a specific way in which each module performs operation has been described in detail in the embodiments related to the method, and will not be described in detail herein.

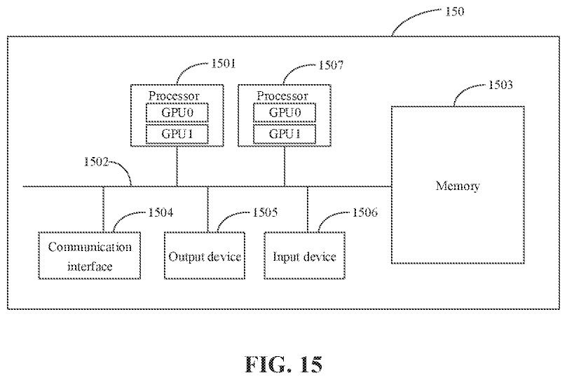

FIG. 15 is a schematic structural diagram of an apparatus for determining a resource disclosure scope 150 provided by the present disclosure. As shown in FIG. 15, the apparatus for determining the resource disclosure scope 150 includes at least one processor 1501 and a memory 1503 for storing one or more instructions executable by the processor 1501, wherein one or more instructions in the memory 1503, when loaded and executed by the processor 1501, cause the processor 1501 to perform the method for determining the resource disclosure scope according to the above-described embodiments.

In addition, the apparatus for determining the resource disclosure scope 150 further includes a communication bus 1502 and at least one communication interface 1504.

The processor 1501 is a GPU, a microprocessor unit, an ASIC, or one or more integrated circuits for controlling program execution of the solutions of the present disclosure.

The communication bus 1502 includes a path for transferring information among the above-described components.

The communication interface 1504 employs any device like a transceiver, and is configured to communicate with other devices or a communication network, such as Ethernet, a radio access network (RAN), a wireless local area network, and the like.

The memory 1503 is, but not limited to, a read-only memory (ROM) or other types of static storage devices that stores static information and instructions, a random access memory (RAM), or other types of dynamic storage devices that can store information and instructions, an electrically erasable programmable read-only memory (EEPROM), a compact disc read-only memory (CD-ROM) or other optical disc memories, an optical disc memory (including a compressed optical disc, a laser disc, an optical disc, a digital versatile disc, a blue-ray disc, and the like), a magnetic disk storage medium or other magnetic storage devices, or any other medium that can be used to carry or store a desired program code in an instruction or data structure form and accessed by a computer. The memory may be independent and be connected to the processing unit via a bus. The memory may also be integrated with the processing unit as a volatile storage medium in the GPU.

The memory 1503 is configured to store instructions for executing solutions of the present disclosure, and execution is controlled by the processor 1501. The processor 1501 is configured to execute the instructions stored in the memory 1503 to implement the functions in the method of the present disclosure.

In a particular implementation, as an embodiment, the processor 1501 includes one or more GPUs, such as GPU0 and GPU1 as shown in FIG. 15.

In a particular implementation, as an embodiment, the apparatus for determining the resource disclosure scope 150 may include one or more processors, such as the processor 1501 and the processor 1507 as shown in FIG. 15. Each of the processors may be a single-CPU processor or a multi-GPU processor. The processors herein may refer to one or more devices, circuits, and/or processing cores for processing data (such as computer program instructions).

In a particular implementation, as an embodiment, the apparatus for determining the resource disclosure scope 150 may further include an output device 1505 and an input device 1506. The output device 1505 communicates with the processor 1501 and may display information in a variety of ways. For example, the output device 1505 may be a liquid crystal display (LCD), a light emitting diode (LED) display device, a cathode ray tube (CRT) display device, a projector, or the like. The input device 1506 communicates with the processor 1501 and may accept user input in a variety of ways. For example, the input device 1506 may be a mouse, a keyboard, a touch screen device, a sensing device, or the like.

Those skilled in the art can appreciate that the structure shown in FIG. 15 does not constitute a limitation on the apparatus for determining the resource disclosure scope 150, and may include more or fewer components than illustrated, or combine certain components, or employ different component arrangements.

The present disclosure further provides an electronic device. The electronic device includes one or more processors, and a memory for storing one or more instructions executable by the processors, wherein one or more instructions, when loaded and executed by the processors, cause the processors to perform the method for determining the resource disclosure scope provided by the embodiments of the present disclosure.

The present disclosure further provides a non-volatile computer-readable storage medium storing at least one instruction therein, wherein the at least one instruction in the non-volatile computer-readable storage medium, when executed by a processor of an electronic device, causes the electronic device to perform the method for determining the resource disclosure scope provided by the above-described embodiments of the present disclosure.

An embodiment of the present disclosure further provides a computer program product including a computer program, wherein the computer program, when executed by a processor, causes the processor to perform the method for determining the resource disclosure scope provided by the above-described embodiments of the present disclosure.

All the embodiments of the present disclosure may be executed separately or in combination with other embodiments, which is considered within the protection scope required by the present disclosure.

What is claimed is:

1. A method for determining a resource disclosure scope, executed by an electronic device, comprising:
displaying, in response to a disclosure scope determining operation on a target resource, at least one disclosure scope option on a resource editing page of the target resource, wherein the disclosure scope option is configured to determine a disclosure scope of a first-type resource, the first-type resource being a resource whose disclosure duration is a preset duration;
determining, in response to an operation on a target option, a disclosure scope of the target resource as a target scope, wherein the target scope indicates to disclose the target resource to a target-type account, the target option is any one of the at least one disclosure scope option, and the target-type account is one or more accounts in a multimedia resource platform; and
publishing the target resource as the first-type resource, wherein a disclosure scope of the published target resource is the target scope.

2. The method for determining the resource disclosure scope according to claim 1, wherein said displaying, in response to the disclosure scope determining operation on the target resource, the at least one disclosure scope option on the resource editing page of the target resource comprises at least one of:
displaying, in response to an editing completion operation on the target resource, the at least one disclosure scope option on the resource editing page, wherein the editing completion operation is an operation on a first publishing option on the resource editing page and the first publishing option is configured to publish the target resource as the first-type resource; and
displaying, in response to an operation on a disclosure scope control on the resource editing page, the at least one disclosure scope option on the resource editing page.

3. The method for determining the resource disclosure scope according to claim 1, wherein said displaying, in response to the disclosure scope determining operation on the target resource, the at least one disclosure scope option on the resource editing page of the target resource comprises:
displaying, in response to the disclosure scope determining operation, a first window on the resource editing page, and displaying the at least one disclosure scope option on the first window.

4. The method for determining the resource disclosure scope according to claim 1, wherein the at least one disclosure scope option comprises at least one of a first option, a second option, a third option, a fourth option, and a fifth option; wherein
in a case that the target option is the first option, the target-type accounts are all accounts in the multimedia resource platform;
in a case that the target option is the second option, the target-type account is a target account, the target account being an account publishing the target resource;
in a case that the target option is the third option, the target-type accounts are a first type of accounts, the first type of accounts being accounts associated with the target account;
in a case that the target option is the fourth option, the target-type accounts are a second type of accounts, the second type of accounts being accounts selected by the target account; and
in a case that the target option is the fifth option, the target-type accounts are all the accounts other than the second type of accounts.

5. The method for determining the resource disclosure scope according to claim 4, wherein said determining, in response to the operation on the target option, the disclosure scope of the target resource as the target scope comprises at least one of:
displaying, in response to an operation on the fourth option, a second window on the resource editing page, wherein the second window comprises the first type of accounts, and determining the target-type accounts in response to an operation on the first type of accounts; and
displaying, in response to an operation on the fifth option, a second window on the resource editing page, wherein the second window comprises the first type of accounts, and determining the target-type accounts in response to an operation on the first type of accounts.

6. The method for determining the resource disclosure scope according to claim 1, wherein the resource editing page comprises a first publishing option and the target resource, wherein the first publishing option is configured to publish the target resource as the first-type resource; and said publishing the target resource as the first-type resource comprises:
publishing, in response to an operation on the first publishing option, the target resource as the first-type resource.

7. The method for determining the resource disclosure scope according to claim 1, further comprising:
saving the target resource in response to a saving operation on the target resource, wherein a disclosure scope of the saved target resource is the target scope;
displaying a resource storage page, wherein the resource storage page comprises the target resource; and
displaying the resource editing page in response to an editing operation on the target resource on the resource storage page, wherein the resource editing page comprises the target resource, and displaying the target option on the resource editing page.

8. The method for determining the resource disclosure scope according to claim 1, further comprising:
saving the target resource in case of an abnormality on the resource editing page, wherein a disclosure scope of the saved target resource is the target scope; and
redisplaying the resource editing page in response to a page recovery operation, wherein the redisplayed resource editing page comprises the target resource, and displaying the target option on the redisplayed resource editing page.

9. The method for determining the resource disclosure scope according to claim 1, further comprising:
hiding the disclosure scope option on the resource editing page.

10. The method for determining the resource disclosure scope according to claim 1, wherein the resource editing page comprises a resource publishing page entry, and the method further comprises:
displaying a resource publishing page in response to an operation on the resource publishing page entry, wherein the resource publishing page comprises the disclosure scope option and a second publishing option, wherein the disclosure scope option is also configured to determine a disclosure scope of a second-type resource, the second-type resource being a resource whose disclosure duration is greater than the preset duration; and the second publishing option is configured to publish the target resource as the second-type resource.

11. An electronic device, comprising:
one or more processors, and
a memory for storing one or more instructions executable by the processors,
wherein the one or more instructions, when loaded and executed by the processors, cause the processors to perform:
displaying, in response to a disclosure scope determining operation on a target resource, at least one disclosure scope option on a resource editing page of the target resource, wherein the disclosure scope option is configured to determine a disclosure scope of a first-type resource, the first-type resource being a resource whose disclosure duration is a preset duration;
determining, in response to an operation on a target option, a disclosure scope of the target resource as a target scope, wherein the target scope indicates to disclose the target resource to a target-type account, the target option is any one of the at least one disclosure scope option, and the target-type account is one or more accounts in a multimedia resource platform; and
publishing the target resource as the first-type resource, wherein a disclosure scope of the published target resource is the target scope.

12. The electronic device according to claim 11, wherein the one or more instructions, when loaded and executed by the processors, cause the processors to perform at least one of:
displaying, in response to an editing completion operation on the target resource, the at least one disclosure scope option on the resource editing page, wherein the editing completion operation is an operation on a first publishing option on the resource editing page and the first publishing option is configured to publish the target resource as the first-type resource; and
displaying, in response to an operation on a disclosure scope control on the resource editing page, the at least one disclosure scope option on the resource editing page.

13. The electronic device according to claim 11, wherein the one or more instructions, when loaded and executed by the processors, cause the processors to perform:
displaying, in response to the disclosure scope determining operation, a first window on the resource editing page, and displaying the at least one disclosure scope option on the first window.

14. The electronic device according to claim 11, wherein the at least one disclosure scope option comprises at least one of a first option, a second option, a third option, a fourth option, and a fifth option; wherein
in a case that the target option is the first option, the target-type accounts are all accounts in the multimedia resource platform;
in a case that the target option is the second option, the target-type account is a target account, the target account being an account publishing the target resource;
in a case that the target option is the third option, the target-type accounts are a first type of accounts, the first type of accounts being accounts associated with the target account;
in a case that the target option is the fourth option, the target-type accounts are a second type of accounts, the second type of accounts being accounts selected by the target account; and
in a case that the target option is the fifth option, the target-type accounts are all the accounts other than the second type of accounts.

15. The electronic device according to claim 14, wherein the one or more instructions, when loaded and executed by the processors, cause the processors to perform at least one of:
displaying, in response to an operation on the fourth option, a second window on the resource editing page, wherein the second window comprises the first type of accounts, and determining the target-type accounts in response to an operation on the first type of accounts; and
displaying, in response to an operation on the fifth option, a second window on the resource editing page, wherein the second window comprises the first type of accounts, and determining the target-type accounts in response to an operation on the first type of accounts.

16. The electronic device according to claim 11, wherein the resource editing page comprises a first publishing option and the target resource, wherein the first publishing option is configured to publish the target resource as the first-type resource; and the one or more instructions, when loaded and executed by the processors, cause the processors to perform:
publishing, in response to an operation on the first publishing option, the target resource as the first-type resource.

17. The electronic device according to claim 11, wherein the one or more instructions, when loaded and executed by the processors, cause the processors to perform:
saving the target resource in response to a saving operation on the target resource, wherein a disclosure scope of the saved target resource is the target scope;
displaying a resource storage page, wherein the resource storage page comprises the target resource; and
displaying the resource editing page in response to an editing operation on the target resource on the resource storage page, wherein the resource editing page comprises the target resource, and displaying the target option on the resource editing page.

18. The electronic device according to claim 11, wherein the one or more instructions, when loaded and executed by the processors, cause the processors to perform:
saving the target resource in case of an abnormality on the resource editing page, wherein a disclosure scope of the saved target resource is the target scope; and
redisplaying the resource editing page in response to a page recovery operation, wherein the redisplayed resource editing page comprises the target resource, and displaying the target option on the redisplayed resource editing page.

19. The electronic device according to claim 11, wherein the one or more instructions, when loaded and executed by the processors, cause the processors to perform:
hiding the disclosure scope option on the resource editing page.

20. A non-volatile computer-readable storage medium storing at least one instruction therein, wherein the at least one instruction, when executed by a processor of an electronic device, cause the electronic device to perform:
displaying, in response to a disclosure scope determining operation on a target resource, at least one disclosure scope option on a resource editing page of the target resource, wherein the disclosure scope option is configured to determine a disclosure scope of a first-type resource, the first-type resource being a resource whose disclosure duration is a preset duration;
determining, in response to an operation on a target option, a disclosure scope of the target resource as a target scope, wherein the target scope indicates to disclose the target resource to a target-type account, and the target option is any one of the at least one disclosure scope option; and
publishing the target resource as the first-type resource, wherein a disclosure scope of the published target resource is the target scope.
